(19) United States
(12) Patent Application Publication
(10) Pub. No.: US 2025/0330381 A1
(43) Pub. Date: Oct. 23, 2025

(54) METHOD AND DEVICE FOR IMPLEMENTING EXTENDED REALITY SERVICE POLICY

(71) Applicant: Beijing Xiaomi Mobile Software Co., Ltd., Beijing (CN)

(72) Inventors: Jinhua WU, Beijing (CN); Jianning LIU, Beijing (CN); Yang SHEN, Beijing (CN); Yuxin MAO, Beijing (CN)

(73) Assignee: Beijing Xiaomi Mobile Software Co., Ltd., Beijing (CN)

(21) Appl. No.: 18/863,563

(22) PCT Filed: May 6, 2022
(86) PCT No.: PCT/CN2022/091318

§ 371 Date: Nov. 6, 2024

(51) Int. Cl. H04L 41/0894; H04L 67/131

(52) U.S. Cl. CPC H04L 41/0894; H04L 67/131

(57) ABSTRACT

Disclosed in embodiments of the present application are a method and device for implementing an extended reality service policy, which can be applied to a long-term evolution (LTE) system, a fifth generation (5G) mobile communication system, a 5G new radio (NR) system, or other future novel mobile communication systems and other communication systems. The method includes: obtaining a URSP rule table sent by a PCF, wherein the URSP rule table includes first indication information; and if the XRM service corresponding to the requested application is consistent with the XRM service corresponding to the indication information, sending an application request message to an AF by means of a PDU session corresponding to the XRM service.

### CROSS-REFERENCE

The present application is a U.S. National Stage of International Application No. PCT/CN2022/091318, filed on May 6, 2022, the contents of which are incorporated herein by reference in its entirety for all purposes.

### TECHNICAL FIELD

The present disclosure relates to the field of communication technologies, and in particular to a method and apparatus for implementing an extended reality service policy.

### BACKGROUND

In wireless communications, the 5th generation (5G) mobile communication networks are developing rapidly, and network capability exposure is an important function of the 5G networks. The 5G networks can provide exposed network functions to third-party service providers, enabling them to adjust network configuration and network resources. In addition, exposed network services can also be used as paid services of operators, creating new network business operation models by delegating some network management rights to the third-party service providers. In the 3rd Generation Partnership Project (3GPP) R15 stage, 5G core networks already have some policy configuration schemes for users and services, and define the User Equipment Routing Selection Policy (URSP), which focuses on defining service-level configuration and management policies, and provides the flexible configuration and management means for network slice, service and session continuity, and other functions defined in the 5G core networks. At present, Extended Reality and Media (XRM) services, such as mobile media services, cloud Augmented Reality (AR)/Virtual Reality (VR), cloud games, video-based machine or drone remote control, are expected to contribute more and more traffic to the 5G networks. Data flows of the XRM services, various data flows, and requirements of these data flows for network transmission all have some common characteristics.

### SUMMARY

Embodiments of the present disclosure provide a method and apparatus for implementing an extended reality service policy.

In a first aspect, embodiments of the present disclosure provide a method for implementing an extended reality service policy, which is applied to a Policy Control Function (PCF), and the method includes:
receiving an Application Function (AF) session creation request message, wherein first indication information in the AF session creation request message is configured to indicate a Packet Data Unit (PDU) session associated with an AF session requested by the AF session creation request message; and
associating the AF session with the PDU session according to the first indication information.

In a second aspect, embodiments of the present disclosure provide another method for implementing an extended reality service policy, which is applied to an Application Function (AF), and the method includes:

sending an AF session creation request message to a PCF through a NEF, wherein the AF session creation request message includes first indication information, and the first indication information is configured to indicate a PDU session associated with an AF session requested by the AF session creation request message.

In a third aspect, embodiments of the present disclosure provide another method for implementing an extended reality service policy, which is applied to a Network Exposure Function (NEF), and the method includes:
receiving an AF session creation request message sent by an AF, wherein the AF session creation request message includes first indication information, and the first indication information is configured to indicate a PDU session associated with an AF session requested by the AF session creation request message; and
authorizing the AF session creation request message, and sending the authorized AF session creation request message to the PCF to enable the PCF to associate the AF session with the PDU session.

In a fourth aspect, embodiments of the present disclosure provide a communication device, which includes a processor which, when invokes a computer program in a memory, executes the method according to the first aspect above.

In a fifth aspect, embodiments of the present disclosure provide a communication device, which includes a processor which, when invokes a computer program in a memory, executes the method according to the second aspect above.

In an sixth aspect, embodiments of the present disclosure provide a communication device, which includes a processor which, when invokes a computer program in a memory, executes the method according to the third aspect above.

### BRIEF DESCRIPTION OF THE DRAWINGS

In order to more clearly illustrate the technical solutions in embodiments of the present disclosure or the background technology, drawings that need to be used in embodiments of the present disclosure or the background technology will be described below.

FIG. 1 is a schematic architecture diagram of a communication system provided by embodiments of the present disclosure;

FIG. 2 is a schematic flowchart of a method for implementing an extended reality service policy provided by embodiments of the present disclosure;

FIG. 3 is a schematic flowchart of a method for implementing an extended reality service policy provided by embodiments of the present disclosure;

FIG. 4 is a schematic flowchart of a method for implementing an extended reality service policy provided by embodiments of the present disclosure;

FIG. 5 is a schematic flowchart of a method for implementing an extended reality service policy provided by embodiments of the present disclosure;

FIG. 6 is a schematic flowchart of a method for implementing an extended reality service policy provided by embodiments of the present disclosure;

FIG. 7 is a schematic flowchart of a method for implementing an extended reality service policy provided by embodiments of the present disclosure;

FIG. 8 is a schematic structural diagram of a communication device provided by embodiments of the present disclosure;

FIG. 9 is a schematic structural diagram of another communication device provided by embodiments of the present disclosure; and

FIG. 10 is a schematic structural diagram of a chip provided by embodiments of the present disclosure.

### DETAILED DESCRIPTION

To facilitate understanding, terms involved in the present application are first introduced.

### 1. Protocol Data Unit (PDU) Session

The PDU session is an association between a terminal device and a Data Network (DN), and is used to provide a PDU connection service. In a layered network structure, such as in an open system interconnection model, a PDU is established at each layer of a transmission system. The PDU contains information from an upper layer, as well as information attached by an entity of the current layer. This PDU is then transmitted to the next lower layer. A physical layer actually transmits these PDUs in the form of a framed bit stream, but the higher layers of a protocol stack construct these PDUs. A receiving system transmits these packets through the protocol stack from bottom to top and separates relevant information in the PDU at each layer of the protocol stack. The information attached to the PDU at each layer is designated for a peer layer of another system to coordinate a communication session at the peer layer. A data segment is processed by stripping a header from a transport layer segment, performing protocol data detection to determine data of a protocol segment as part of data of the transport layer segment, and performing flag verification and stripping. A technique for processing the data segment is also provided, where a header portion of a protocol data unit is received. The received header portion is used to determine the number of bytes of data to be stored in an application space. Furthermore, the received header portion is used to determine the next header portion of the next protocol data unit. Then, a peek command is sent to obtain the next header portion. In addition, a technique for performing a cyclic redundancy check using a stored partial cyclic redundancy check digest and residual data is provided.

### 2. Quality of Service (QoS) Parameter

The QoS parameter in embodiments of the present disclosure include one or more of the following parameters:

### 1) 5G QoS Identifier (5QI)

5QI is a scalar and is used to index the corresponding 5G QoS characteristic. 5QI is divided into standardized 5QI, pre-configured 5QI and dynamically allocated 5QI. For the standardized 5QI, there is a one-to-one correspondence with a set of standardized 5G QoS characteristic values. For the pre-configured 5QI, the corresponding 5G QoS characteristic value is pre-configured on an access network device. For the dynamically allocated 5QI, the corresponding 5G QoS characteristic is sent by a core network device to the access network device through a QoS profile.

### 2) Allocation and Retention Priority (ARP)

ARP includes a priority, a preemptive capability, and a preemption capability.

### 3) Guaranteed Flow Bit Rate (GFBR)

GFBR represents a bit rate expected to be provided to a Guaranteed Bit Rate (GBR) QoS flow.

### 4) Maximum Flow Bit Rate (MFBR)

MFBR limits a bit rate provided to the GBR QoS flow, that is, the maximum bit rate provided to the GBR QoS flow. If the bit rate is exceeded, the data packet can be discarded.

### 5) Reflective QoS Attribute (RQA)

QA is configured to indicate that a service transmitted using the corresponding QoS flow uses the reflective QoS.

### 6) QNC

QNC is configured to indicate that the access network device whether to notify the network when the GFBR cannot be met during a use period of the QoS flow.

### 3. QoS Model

In a 5G system, in order to ensure the end-to-end service quality of the service, a 5G QoS model based on QoS flow is proposed. The 5G QoS model is used to support the GBR QoS flow and the non-GBR QoS flow. Data packets controlled by the same QoS flow are used to receive the same transmission processing (such as scheduling, the admission threshold, etc.).

FIG. 1 is a schematic architecture diagram of a communication system provided by embodiments of the present disclosure. Referring to FIG. 1, the communication system may include, but is not limited to, a network side device and a terminal device. The number and forms of devices shown in FIG. 1 are only as an example and do not constitute a limitation on embodiments of the present disclosure. The communication system may include two or more network side devices, two or more terminal devices in practical applications. As an example for illustration, the communication system shown in FIG. 1 includes a network side device 101 and a terminal device 102.

It should be noted that the technical solutions of embodiments of the present disclosure may be applied to various communication systems, for example, a long term evolution (LTE) system, a 5th generation (5G) mobile communication system, a 5G new radio (NR) system, or other future new mobile communication systems. It should also be noted that the sidelink in embodiments of the present disclosure can also be called a sidelink or a direct link.

The network side device 101 in embodiments of the present disclosure is an entity on a network side for sending or receiving signals. For example, the network side device 101 may be an evolved NodeB (eNB), a transmission reception point (TRP), a next generation NodeB (gNB) in a NR system, a base station in other future mobile communication systems, or an access node in a wireless fidelity (WiFi) system. Embodiments of the present disclosure do not limit the specific technology and specific device form adopted by the network side device. The network side device provided by embodiments of the present disclosure may be composed of a central unit (CU) and distributed units (DU). The CU may also be called a control unit. Using the CU-DU structure allows to split a protocol layer of the network side device, such as the base station, a part of functions of the protocol layer is centrally controlled in the CU, some or all of the remaining functions of the protocol layer are distributed in the DUs, and the CU centrally controls the DUs.

The terminal device 102 in embodiments of the present disclosure is an entity on a user side for receiving or sending signals, such as a mobile phone. The terminal device may also be called a terminal, a user equipment (UE), a mobile station (MS), a mobile terminal (MT), and so on. The terminal device may be a car with a communication function, a smart car, a mobile phone, a wearable device, a tablet Pad, a computer with a wireless transceiving function, a virtual reality (VR) terminal device, an augmented reality (AR) terminal device, a wireless terminal device in an industrial control, a wireless terminal device in a self-driving, a wireless terminal device in a remote medical surgery, a wireless terminal device in a smart grid, a wireless terminal device in a transportation safety, a wireless terminal device in a smart city, a wireless terminal device in a smart home, etc. Embodiments of the present disclosure do not limit the specific technology and the specific device form adopted by the terminal device.

At present, XRM services, such as AR/VR, cloud games, video-based machine or drone remote control in mobile media services, are expected to contribute more and more traffic to the 5G networks. Data flows of the XRM services, various data flows, and requirements of these data flows for network transmission all have some common characteristics. The effective identification and use of these characteristics will be more conducive to the transmission and control of networks and services, as well as to service assurance and user experience.

The XRM services require the 5GS system to comprehensively consider the QoS characteristics of the relevant data flows of the service, such as whether a parameter such as a delay critical GBR data flow, the GFBR, a Packet Delay Budget (PDB), a Default Maximum Data Burst Volume (MDBV) can be met and coordinated at the same time. It involves multiple XRM data flows of a UE, and XRM data flows of multiple UEs, and the consistency of QoS authorization and execution between each other.

Therefore, using the same PDU session for all data flows of an XRM service of the same UE is a prerequisite for maximally satisfying the QoS authorization and execution consistency of XRM data flows based on the existing architecture and functional support.

However, the 5GS system currently does not have a complete mechanism to ensure that all data flows of an XRM service of the UE will be transmitted using only one PDU session.

It can be understood that the communication system described in embodiments of the present disclosure is intended to illustrate the technical solutions of embodiments of the present disclosure more clearly, and does not constitute a limitation on the technical solutions provided by embodiments of the present disclosure. Those of ordinary skill in the art will know that with an evolution of a system architecture and an emergence of a new service scenario, the technical solutions provided by embodiments of the present disclosure are also applicable to similar technical problems.

A method and apparatus for implementing an extended reality service policy provided by the present disclosure will be described in detail below with reference to the accompanying drawings.

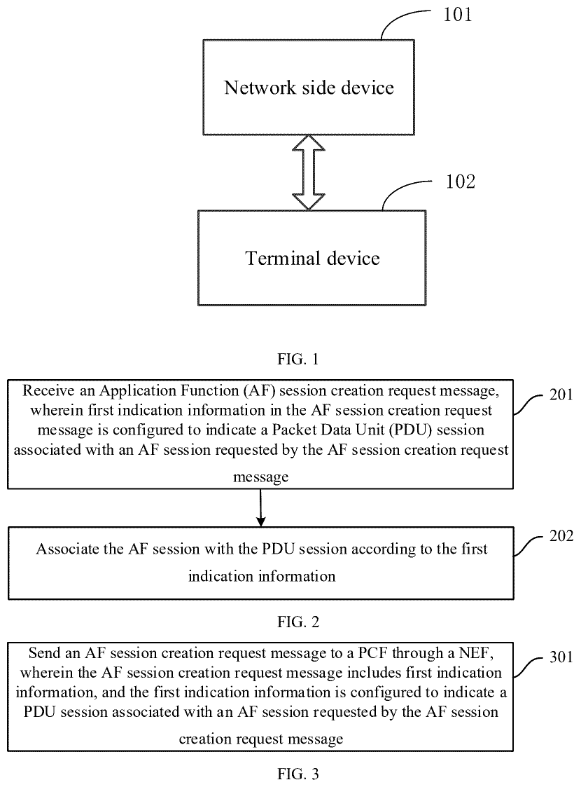

Reference is made to FIG. 2, which is a schematic flowchart of a method for implementing an extended reality service policy provided by embodiments of the present disclosure. The method is applied to a PCF. As shown in FIG. 2, the method may include but is not limited to steps 201 to 202.

In the step 201, an Application Function (AF) session creation request message is received, and first indication information in the AF session creation request message is configured to indicate a Packet Data Unit (PDU) session associated with an AF session requested by the AF session creation request message.

In an embodiment of the present disclosure, the AF creates the AF session by sending, through a NEF, the AF session creation request message to the PCF, and the PCF receives the AF session creation request message which is sent by the AF through the NEF. The first indication information in the AF session creation request message and information corresponding to the PDU session have the same type, and the first indication information is used to determine the PDU session corresponding to the AF session.

In the step 202, the AF session is associated with the PDU session according to the first indication information.

In an embodiment of the present disclosure, the PCF associates the AF session with the corresponding PDU session according to the indication information in the AF session creation request message to realize data flow transmission from the UE to the AF.

The AF session is determined by receiving the AF session creation request message for authorization, and the PDU session associated with the AF session requested by the AF session creation request message is obtained according to the second indication information, so that the PDU session is associated with the AF session by the PCF. Accordingly, for an XRM service of the same UE, data flows of the XRM service can use the same PDU session, which is beneficial to improve the transmission efficiency of the service data flow in the session and avoid waste of communication resources.

In an embodiment, associating the AF session with the PDU session according to the first indication information includes:
updating policy information of the PDU session according to the first indication information to associate the AF session with the PDU session.

In an embodiment of the present disclosure, the PCF updates the policy information of the PDU session according to the first indication information in the AF session creation request message, so that policy information of the PDU session is consistent with that of the AF session, in order to associate the AF session with the PDU session.

In an embodiment, the method further includes:
sending a User Equipment Route Selection Policy (URSP) rule table to a UE, and the URSP rule table includes second indication information, and the second indication information is configured to indicate a corresponding XRM service.

In an embodiment of the present disclosure, the URSP rule table is provided to the UE by the PCF in the core network to inform the UE of the route selection policy. The URSP rule table contains one or more route selection descriptors, each of which has a different route selection descriptor precedence. In order to support the transmission of the data flow related to the XRM service, the present disclosure newly adds the first indication information to the URSP rule table, and the first indication information is configured to indicate the corresponding XRM service.

After the UE registers with the network, a core network will perform a UE policy association creation process. In the UE policy association creation process, when an Access and Mobility Management Function (AMF) determines to establish the UE policy association, the AMF interacts with the PCF, so that the PCF sends a UE policy container containing the UE policy information to the UE to update the UE configuration. In an embodiment of the present disclosure, the UE policy container includes the URSP.

In some embodiments of the present disclosure, the UE policy association creation process involves roaming and non-roaming situations. In the non-roaming situation, a Visited Policy Control Function (V-PCF) does not involve this process, and a role of a Home Policy Control Function (H-PCF) is performed by the PCF. In the roaming situation, the V-PCF interacts with the AMF, and the H-PCF interacts with the V-PCF.

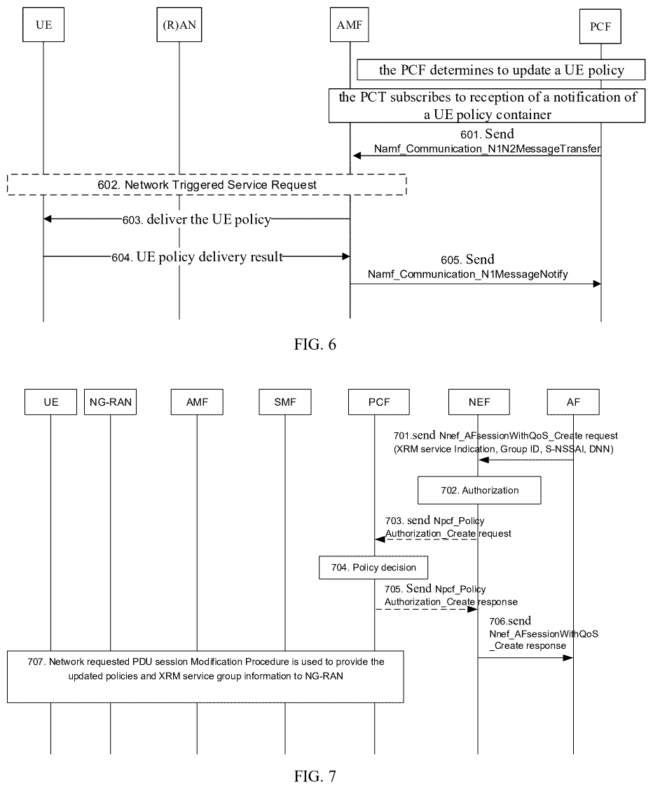

FIG. 6 is a schematic flowchart of a method for implementing an extended reality service policy provided by embodiments of the present disclosure. As shown in FIG. 6, a process of enabling the PCF to send a UE policy container (including a URSP policy of a UE) including UE policy information to the UE specifically includes:
after the PCF determines to update the UE policy, it checks whether it has subscribed to a notification of a UE response to the AMF updating the UE policy information, and if not, the PCF will subscribe to the AMF to receive the notification about the UE response to the UE policy information update.

In step 601, the PCF sends the Namf_Communication_NIN2Message Transfer message to the AMF. The message includes SUPI and a UE policy container.

In step 602, the AMF determines, according to information such as whether the UE is registered in the 3GPP network and/or the non-3GPP network, whether the AMF can access the UE through the 3GPP network access or the non-3GPP network access, etc., whether to send the UE policy container in the Namf_Communication_NIN2MessageTransfer message to the UE.

In step 603, a UE policy is delivered. If the UE is in a Connection Management (CM)-CONNECTED state accessed through the 3GPP or the non-3GPP, the AMF will transparently transmit, to the UE, the UE policy container and the UE policy information therein received from PCF. The UE policy container includes the URSP list.

In step 604, a UE policy delivery result is fed back. The UE obtains the UE policy information in the received UE policy container to update the UE policy in the UE, and informs the AMF of the update result of the UE policy.

In step 605, the AMF uses Namf_Communication_N1MessageNotify to forward the UE policy update result of the UE to the PCF.

In an embodiment of the present disclosure, in order to support the use of the same PDU session to transmit all data flows of the XRM service, at least one of the XRM service indication information or the application description information is newly added to the URSP for indication. The XRM service indication information is used to directly indicate that if the XRM service corresponding to the requested application is consistent with the XRM service indication information, the application request message corresponding to the requested application is transmitted through the PDU session corresponding to the XRM service. The application description information is used to indirectly inform the UE of the XRM service to be transmitted using the same PDU session.

The URSP rule table is shown in Table 1 and Table 2.

TABLE 1

| | | | PCF permitted | |
|---|---|---|---|---|
| Information | | | to modify in a | |
| name | Description | Category | UE context | Scope |
| Rule Precedence | Determines the order the | Mandatory | Yes | UE context |
| | URSP rule is enforced in | | | |
| | the UE | | | |
| Traffic | This part defines the | Mandatory | | |
| descriptor | Traffic descriptor | | | |
| | components for the | | | |
| | URSP rule | | | |
| Application | It consists of OSId and | Optional | Yes | UE Context |
| Descriptors | OSAppId(s). | | | |
| IP descriptors | Destination IP 3 tuple(s) | Optional | Yes | UE Context |
| | (IP address or IPv6 | | | |
| | network prefix, port | | | |
| | number, protocol ID of | | | |
| | the protocol above IP) | | | |

In Table 1, the Application Descriptors are the application description information, and the UE can be indirectly informed of the XRM service indication information by the Application Descriptors in the URSP rule table, that is, the UE obtains the corresponding XRM service identifier or XRM group identifier according to the XRM service indication information indicated by the Application Descriptors. The USRP rule table with the Application Descriptors added is sent to the UE through the process shown in FIG. 6 to update the UE policy.

TABLE 2

| | | | PCF permitted | |
|---|---|---|---|---|
| | | | to modify in | |
| Information name | Description | Category | URSP | Scope |
| Route Selection | Determines the order in | Mandatory | Yes | UE context |
| Descriptor | which the Route | | | |
| Precedence | Selection Descriptors | | | |
| | are to be applied | | | |
| Route selection | This part defines the | Mandatory | | |
| components | route selection | | | |
| | components | | | |
| Session and | One single value of SSC | Optional | Yes | UE Context |
| Service | mode | | | |
| Continuity (SSC) | | | | |
| Mode Selection | | | | |
| Network Slice | Either a single value or a | Optional | Yes | UE Context |
| Selection | list of values of S- | | | |
| | NSSAI(s) | | | |
| DNN Selection | Either a single value or a | Optional | Yes | UE Context |
| | list of values of DNN(s) | | | |
| PDU Session | One single value of PDU | Optional | Yes | UE Context |
| Type Selection | Session Type | | | |
| Non-Seamless | Indicates if the traffic of | Optional | Yes | UE Context |
| Offload indication | the matching application | | | |
| | is to be offloaded to non- | | | |
| | 3GPP access outside of a | | | |
| | PDU Session | | | |
| XRM Indication | Indicates that traffic of | Optional | Yes | UE Context |
| | the matching XRM | | | |
| | service application is to | | | |
| | be transferred by the | | | |
| | same PDU session. | | | |

In Table 2, the XRM indication is the newly added XRM service indication information. The UE can determine the XRM service identifier or the XRM group identifier according to the XRM indication. The USRP rule table with the XRM service indication information added is sent to the UE through the process shown in FIG. 6 to update the UE policy.

In an embodiment, the UE evaluates the URSP rule table in the order of Rule Precedence and determines if the application is matching the traffic descriptor of any URSP rule. When a URSP rule is determined to be applicable for a given application (e.g. XRM service), the UE shall select a Route Selection Descriptor within this URSP rule in the order of the Route Selection Descriptor Precedence. When a valid Route Selection Descriptor is found, the UE determines if there is an existing PDU Session that matches all components in the selected Route Selection Descriptor. The UE compares the components of the selected Route Selection Descriptor with the existing PDU Session(s).

In an embodiment, the second indication information includes at least one of:
XRM service indication information; or
application description information.

In some embodiments of the present disclosure, the method further includes:
sending the URSP rule table to the UE through a UE configuration update process.

In an embodiment of the present disclosure, after the UE is successfully registered, the UE selects the PCF by performing Access Management (AM) session association, and the PCF sends the URSP rule to the UE through the UE configuration update process. In some embodiments of the present disclosure, the method further includes:
updating the URSP rule table according to operator policy information, subscription information or capability information of the UE, and sending the updated URSP rule table to the UE.

In an embodiment, the first indication information includes at least one of:
S-NSSAI and a DNN; or
an Application ID, and the Application ID corresponds to the S-NSSAI and the DNN.

In an embodiment, the AF session creation request message includes at least one of:
an XRM service identifier;
an XRM group identifier;
a UE address or a UE identifier;
an AF identifier;
data flow description information; or
a QoS parameter.

In an embodiment, the AF session creation request message is authorized by a NEF.

In an embodiment of the present disclosure, the NEF authorizes the AF session creation request message, and the PCF receives the authorized AF session creation request message.

In an embodiment, the method further includes:
generating a policy decision feedback message according to the AF session creation request message authorized by the NEF and sending the policy decision feedback message to the NEF.

In an embodiment of the present disclosure, after the NEF sends the authorized AF session creation request message to the PCF, the PCF will further make a policy decision and determines to update, according to the first indication information specified in the AF session creation request message, the policy information used by the PDU session. The PCF notifies the AF of the result of the policy decision according to the policy decision feedback message.

In an embodiment, the policy information includes a Policy and Charging Control (PCC) rule and/or a QoS policy.

The PCF allocates the QoS parameters for the PCC rule or the QoS policy, and provides the PCC rule and/or the QoS policy to a Session Management Function (SMF), so that the SMF upgrades or downgrades the QoS according to a network condition and the PCC rule and/or the QoS policy. The QoS parameter is derived from the AF session creation request message.

Reference is made to FIG. 3, which is a schematic flowchart of a method for implementing an extended reality service policy provided by embodiments of the present disclosure. The method is applied to an AF. As shown in FIG. 3, the method may include but is not limited to step 301.

In the step 301, an AF session creation request message is sent to a PCF through a NEF, the AF session creation request message includes first indication information, and the first indication information is configured to indicate a PDU session associated with an AF session requested by the AF session creation request message.

In an embodiment of the present disclosure, the AF creates the AF session by sending, through the NEF, the AF session creation request message to the PCF. The first indication information in the AF session creation request message and information corresponding to the PDU session have the same type, and the first indication information is used to determine the corresponding PDU session and associate the AF session with the corresponding PDU session to realize data flow transmission from the UE to the AF.

The AF session creation request message is sent to the PCF through the NEF to create the AF session, and the PDU session associated with the AF session requested by the AF session creation request message is obtained according to the second indication information, so that the PDU session is associated with the AF session by the PCF. Accordingly, for an XRM service of the same UE, data flows of the XRM service can use the same PDU session, which is beneficial to improve the transmission efficiency of the service data flow in the session and avoid waste of communication resources.

In an embodiment, the method further includes:
receiving, through the NEF, an AF session creation feedback message sent by the PCF.

In an embodiment, the method further includes:
receiving an application request message which is sent by a UE through the PDU session, the application request message includes information corresponding to the PDU session, and the information corresponding to the PDU session is the first indication information.

In an embodiment of the present disclosure, the AF receives the application request message which is sent by the UE through the PDU session to obtain the information corresponding to the PDU session and to obtain the first indication information in the AF session creation request message. The first indication information in the AF session creation request message is the information corresponding to the PDU session.

In an embodiment, the AF session creation request message further includes at least one of:
an XRM service identifier; or
an XRM group identifier.

In an embodiment of the present disclosure, the data flow corresponding to the XRM service can be identified according to the XRM service identifier, and all data flows in the XRM service group can be identified according to the XRM group identifier, so that the data flows corresponding to the XRM service are transmitted using the same PDU.

In an embodiment, the first indication information includes at least one of:
S-NSSAI and a DNN; or
an Application ID, and the Application ID corresponds to the S-NSSAI and the DNN.

In an embodiment of the present disclosure, the first indication information in the AF session creation request message is consistent with the information corresponding to the PDU session. The Application ID can be mapped to the S-NSSAI and the DNN.

In some embodiments of the present disclosure, the XRM service identifier is carried by the Application ID.

In an embodiment, the AF session creation request message further includes at least one of:
a UE address or a UE identifier;
an AF identifier;
data flow description information; or
a Quality of Service (QoS) parameter.

The AF session creation request message further includes the UE address, the UE identifier, the AF identifier, the flow description, and the QoS parameter.

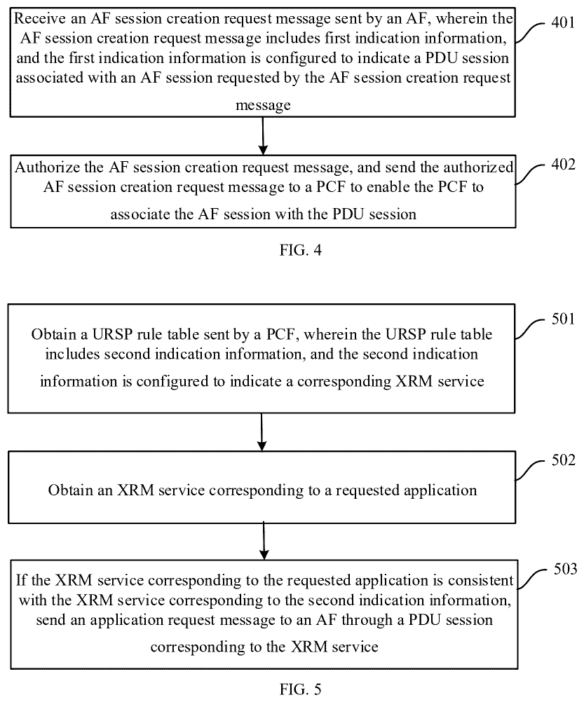

Reference is made to FIG. 4, which is a schematic flowchart of a method for implementing an extended reality service policy provided by embodiments of the present disclosure. The method is applied to a NEF. As shown in FIG. 4, the method may include but is not limited to steps 401 to 402.

In the step 401, an AF session creation request message sent by an AF is received, the AF session creation request message includes first indication information, and the first indication information is configured to indicate a PDU session associated with an AF session requested by the AF session creation request message.

In an embodiment of the present disclosure, the NEF receives the AF session creation request message sent by the AF. The first indication information in the AF session creation request message and information corresponding to the PDU session have the same type, and the first indication information is used to determine the corresponding PDU session and associate the AF session with the corresponding PDU session to realize data flow transmission from the UE to the AF.

In the step 402, the AF session creation request message is authorized, and the authorized AF session creation request message is sent to the PCF to enable the PCF to associate the AF session with the PDU session.

In an embodiment of the present disclosure, the NEF authorizes the AF session creation request message, retains the AF session corresponding to the authorized AF session creation request message, and deletes the AF session corresponding to the unauthorized AF session creation request message. The authorized AF session creation request message is sent to the PCF, so that the PCF associates the AF session corresponding to the authorized AF session creation request message with the PDU session, thereby realizing the data flow transmission from the UE to the AF.

The AF session is determined by authorizing the AF session creation request message, and the PDU session associated with the AF session requested by the AF session creation request message is obtained according to the second indication information, so that the PDU session is associated with the AF session by the PCF. Accordingly, for an XRM service of the same UE, data flows of the XRM service can use the same PDU session, which is beneficial to improve the transmission efficiency of the service data flow in the session and avoid waste of communication resources.

In an embodiment, the method further includes:
sending an AF session creation feedback message to the AF to notify the AF of an authorization result of the AF session creation request message.

In an embodiment of the present disclosure, the NEF generates the AF session creation feedback message according to the result of the authorization of the AF session creation request message, and sends the AF session creation feedback message to the AF to notify the AF of the authorization result.

In an embodiment, the method further includes:
receiving a policy decision feedback message sent by the PCF, and feeding back the policy decision feedback message to the AF.

In an embodiment of the present disclosure, after the NEF sends the authorized AF session creation request message to the PCF, the PCF will further make a policy decision and determines to update, according to the first indication information specified in the AF session creation request message, the policy information used by the PDU session. The PCF notifies the AF of the result of the policy decision according to the policy decision feedback message.

In an embodiment, the first indication information includes at least one of:
S-NSSAI and a DNN; or
an Application ID, and the Application ID corresponds to the S-NSSAI and the DNN.

In an embodiment, the AF session creation request message includes at least one of:
an XRM service identifier;
an XRM group identifier;
a UE address or a UE identifier;
an AF identifier;
data flow description information; or
a QoS parameter.

In an embodiment, the method further includes:
creating a Time Sensitive Communication and Time Synchronization Function (TSCTSF) according to the AF identifier or the QoS parameter to communicate with the PCF.

In an embodiment of the present disclosure, the NEF can determine, according to the AF identifier or the QoS parameter in the AF session creation request message, to invoke the TSCTSF to communicate with the PCF, and send the authorized AF session creation request message to the PCF, so that the PCF associates the AF session with the PDU session.

Reference is made to FIG. 5, which is a schematic flowchart of a method for implementing an extended reality service policy provided by embodiments of the present disclosure. The method is applied to a UE. As shown in FIG. 5, the method may include but is not limited to steps 501 to 503.

In the step 501, a URSP rule table sent by a PCF is obtained, the URSP rule table includes second indication information, and the second indication information is configured to indicate a corresponding XRM service.

In an embodiment of the present disclosure, the URSP rule table is provided to the UE by the PCF in the core network to inform the UE of the route selection policy. The URSP rule table contains one or more route selection descriptors, each of which has a different route selection descriptor precedence. In order to support the transmission of the data flow related to the XRM service, the present disclosure newly adds the second indication information to the URSP rule table, and the second indication information is configured to indicate the corresponding XRM service.

In the step 502, an XRM service corresponding to a requested application is obtained.

In an embodiment of the present disclosure, when the UE initiates an application-related request to the AF, the UE obtains the XRM service corresponding to the application to determine whether it complies with the rule in the URSP.

In the step 503, if the XRM service corresponding to the requested application is consistent with the XRM service corresponding to the second indication information, an application request message is sent to an Application Function (AF) through a Packet Data Unit (PDU) session corresponding to the XRM service.

In an embodiment of the present disclosure, if the XRM service corresponding to the requested application is consistent with the XRM service corresponding to the second indication information, it means that the XRM service corresponding to the requested application can be selected in a route manner according to the rule in the URSP. The application request message is sent to the AF through the PDU session corresponding to the XRM service, so that all data flows of an XRM service in the UE are transmitted using one PDU session.

The PDU session corresponding to the transmission of the application request message is determined by the XRM service corresponding to the requested application and the second indication information in the URSP rule table, and the application request message is sent to the AF according to the existing PDU session, so that the AF creates an AF session associated with the PDU session. Accordingly, for an XRM service of the same UE, data flows of the XRM service can use the same PDU session, which is beneficial to improve the transmission efficiency of the XRM service and avoid waste of communication resources.

In an embodiment, the second indication information includes at least one of:
XRM service indication information; or
application description information.

In an embodiment of the present disclosure, in order to support the use of the same PDU session to transmit all data flows of the XRM service, at least one of the XRM service indication information or the application description information is newly added to the URSP for indication. The XRM service indication information is used to directly indicate that if the XRM service corresponding to the requested application is consistent with the XRM service indication information, the application request message corresponding to the requested application is transmitted through the PDU session corresponding to the XRM service. The application description information is used to indirectly inform the UE of the XRM service to be transmitted using the same PDU session.

The URSP rule table is shown in Table 1 and Table 2. In Table 1, the Application Descriptors are the application description information, and the UE can be indirectly informed of the XRM service indication information by the Application Descriptors in the URSP rule table, that is, the UE obtains the corresponding XRM service identifier or XRM group identifier according to the indication information indicating the XRM service.

In Table 2, the XRM indication is the newly added XRM service indication information. The UE can determine the XRM service identifier or the XRM group identifier according to the XRM indication.

In an embodiment, the UE evaluates the URSP rule table in the order of Rule Precedence and determines if the application is matching the traffic descriptor of any URSP rule. When a URSP rule is determined to be applicable for a given application (e.g. XRM service), the UE shall select a Route Selection Descriptor within this URSP rule in the order of the Route Selection Descriptor Precedence. When a valid Route Selection Descriptor is found, the UE determines if there is an existing PDU Session that matches all components in the selected Route Selection Descriptor. The UE compares the components of the selected Route Selection Descriptor with the existing PDU Session(s).

In an embodiment, the application request message includes information corresponding to the PDU session to enable the PCF to associate an AF session created by the AF with the PDU session.

In an embodiment of the present disclosure, the PDU session is a session between the UE and the PCF, and the AF session is a session between the PCF and the AF. In order to perform data transmission between the UE and the AF, the AF session needs to be associated with the PDU session to establish a transmission channel from the UE to the AF. The corresponding PDU is determined by the information corresponding to the PDU session in the application request message to associate the PDU with the AF session created by the AF.

In an embodiment, the information corresponding to the PDU session includes at least one of:
Network Slice Selection Assistance Information (S-NSSAI) and a Data Network Name (DNN); or
an Application ID, and the Application ID corresponds to the S-NSSAI and the DNN.

In an embodiment of the present disclosure, the corresponding PDU session is determined by the S-NSSAI and the DNN. Alternatively, the corresponding PDU session is determined by the Application ID, and the Application ID can be mapped to the S-NSSAI and the DNN.

In an embodiment, the application request message includes an XRM service identifier or an XRM group identifier.

In an embodiment of the present disclosure, the XRM service identifier or the XRM group identifier in the application request message indicates the XRM service corresponding to the requested application. By determining whether the XRM service identifier or the XRM group identifier in the application request message is consistent with the XRM corresponding to the second indication information in the URSP, it is determined whether to send the application request message to the AF through the PDU session corresponding to the XRM service.

FIG. 7 is a schematic flowchart of a method for implementing an extended reality service policy provided by embodiments of the present disclosure. As shown in FIG. 7, the flow is as follows.

In step 701, an AF creates an AF session through the Nnef AFsessionWithQoS_Create request message, i.e., an AF session creation request message. The AF carries an XRM service identifier or an XRM group identifier, a DNN, S-NSSAI, and a UE address or a UE identifier, an AF identifier, an Application ID, flow description(s), a QoS parameter and other information in the request message. In some embodiments of the present disclosure, the XRM group identifier contains Group ID, which can be used to identify all data flows in the XRM service group. In some embodiments of the present disclosure, the XRM service identifier here is used to identify the flow as the XRM service. In some embodiments of the present disclosure, the XRM service identifier can also be implicitly carried by the Application ID.

In some embodiments of the present disclosure, the S-NSSAI and the DNN in the request message can be obtained from the S-NSSAI and the DNN carried in the application request message sent by the UE to the AF. Alternatively, the S-NSSAI and the DNN are obtained by mapping an external Application ID carried in the application request message sent by the UE to the AF.

In step 702, a NEF authorizes the Nnef AFsessionWithQoS_Create request message and determines whether to use an AF session corresponding to the Nnef AFsession WithQoS_Create request.

In some embodiments of the present disclosure, the NEF performs the relevant mapping to map the Application ID to the DNN and the S-NSSAI. Alternatively, the NEF performs XRM service group identifier mapping from external to internal.

In step 703, after the NEF authorizes the Nnef_AFsessionWithQoS_Create request, it determines, according to information provided by the AF (such as the QoS parameter, the AF identifier), whether to invoke a TSCTSF or to directly contact the PCF to establish an AF session with the required QoS process. The PCF receives the XRM service identifier or the XRM group identifier, the DNN, the S-NSSAI, and the UE address or the UE identifier, the AF identifier, the Application ID, the Flow description(s), the QoS parameter and other information that are provided by the AF from the NEF or the TSCTSF.

The NEF triggers the Npcf_ PolicyAuthorization_Create message and sends the authorized Npcf_ Policy Authorization_Create message to the PCF, carrying the above XRM service related information and the QoS information for the PCF to make the policy decision.

In the step 704, policy decision and authorization are performed, i.e., a PCC rule and the QoS parameter are generated, based on the S-NSSAI and the DNN received in the Npcf_Policy Authorization_Create message, for the data flow corresponding to the XRM service. The PCF generates or updates the PCC rule based on the NEF request, and triggers the Npcf_SMPolicyControl_UpdateNotify to update, according to the PCC rule and the QoS policy related to the Nnef_AFsessionWithQOS_Create request, the policy information of the corresponding PDU session in the SMF.

In step 705, the PCF sends the Npcf_ PolicyAuthorization_Create response message to the NEF to inform the result of the policy decision.

In step 706, the NEF sends the Nnef_AFsessionWithQoS_Create response message to the AF to inform the AF of the authorization result, that is, whether the Nnef_AFsessionWithQoS_Create request message is authorized.

In step 707, the SMF determines the authorized QoS of a QoS flow using the PCC rule and the QoS parameter received in the step 704 and initiates the Network requested PDU Session Modification procedure to provide updated QoS attributes as user plane policies and XRM service group Information for the correlated traffic flows to the Next Generation Radio Area Network (NG-RAN).

In the above embodiments provided by the present disclosure, the methods provided in embodiments of the present disclosure are introduced from perspectives of the network side device and the terminal device, respectively. In order to implement various functions in the methods provided by the above embodiments of the present disclosure, the network side device and the terminal device may include a hardware structure and a software module, and implement the above functions in a form of the hardware structure, the software module, or the hardware structure plus the software module. A certain function among the above mentioned functions may be implemented in the form of the hardware structure, the software module, or the hardware structure plus the software module.

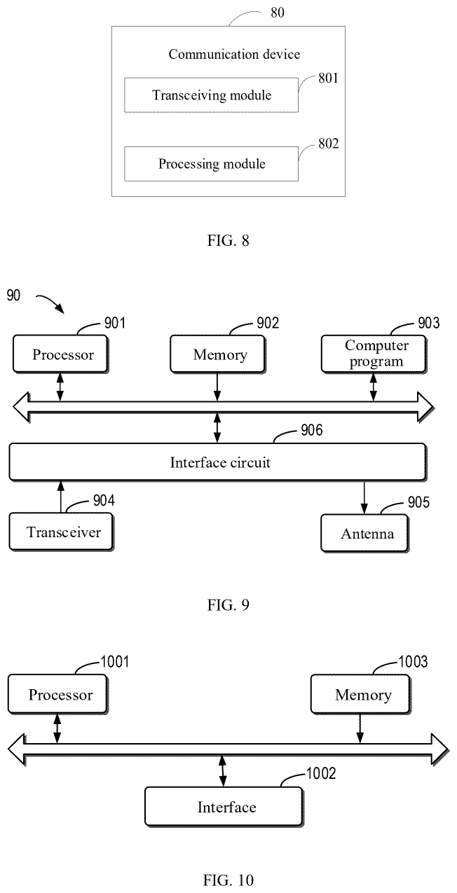

Reference is made to FIG. 8, which is a schematic structural diagram of a communication device 80 provided by embodiments of the present disclosure. The communication device 80 shown in FIG. 8 may include a transceiving module 801 and a processing module 802. The transceiving module 801 may include a sending module and/or a receiving module, the sending module is configured to implement a sending function, the receiving module is configured to implement a receiving function, and the transceiving module 801 may implement the sending function and/or the receiving function.

The communication device 80 may be a terminal device (such as the terminal device in the foregoing method embodiments), may also be a device in the terminal device, and may also be a device that can be matched and used with the terminal device. Or, the communication device 80 may be a network side device, may also be a device in the network side device, and may also be a device that can be matched and used with the network side device.

The communication device 80 is a PCF device, including:
a first transceiving module, configured to receive an Application Function (AF) session creation request message, and first indication information in the AF session creation request message is configured to indicate a Packet Data Unit (PDU) session associated with an AF session requested by the AF session creation request message; and
a session association module, configured to associate the AF session with the PDU session according to the first indication information.

The communication device 80 is an AF device, including:
a second transceiving module, configured to send an Application Function (AF) session creation request message to a Policy Control Function (PCF) through a Network Exposure

Function (NEF), the AF session creation request message includes first indication information, and the first indication information is configured to indicate a Packet Data Unit (PDU) session associated with an AF session requested by the AF session creation request message.

The communication device 80 is a NEF device, including:
a third transceiving module, configured to receive an Application Function (AF) session creation request message sent by an AF, the AF session creation request message includes first indication information, and the first indication information is configured to indicate a Packet Data Unit (PDU) session associated with an AF session requested by the AF session creation request message; and
an authorization module, configured to authorize the AF session creation request message, and sending the authorized AF session creation request message to a Policy Control Function (PCF) to enable the PCF to associate the AF session with the PDU session.

The communication device 80 is a UE device, including:
a rule updating module, configured to obtain a User Equipment Route Selection Policy (URSP) rule table sent by a Policy Control Function (PCF), the URSP rule table includes second indication information, and the second indication information is configured to indicate a corresponding Extended Reality and Media (XRM) service;
a service obtaining module, configured to obtain an XRM service corresponding to a requested application; and
a fourth transceiving module, configured to, if the XRM service corresponding to the requested application is consistent with the XRM service corresponding to the second indication information, send an application request message to an Application Function (AF) through a Packet Data Unit (PDU) session corresponding to the XRM service.

Reference is made to FIG. 9, which is a schematic structural diagram of another communication device 90 provided by embodiments of the present disclosure. The communication device 90 may be a network side device, may also be a terminal device (such as the terminal device in the foregoing method embodiments), may also be a chip, a chip system, or a processor that supports the network side device to implement the above method, and may also be a chip, a chip system, or a processor that supports the terminal device to implement the above method. The device may be configured to implement the method as described in the above method embodiments, and for details, reference may be made to the descriptions in the above method embodiments.

The communications device 90 may include one or more processors 901. The processor 901 may be a general-purpose processor or a special-purpose processor. For example, it may be a baseband processor or a central processing unit. The baseband processor may be configured to process a communication protocol and communication data, and the central processing unit may be configured to control a communication device (such as a base station, a baseband chip, the terminal device, a terminal device chip, a DU or a CU, etc.) execute computer programs, and process data of computer programs.

In an embodiment, the communication device 90 may further include one or more memories 902 having stored therein a computer program 903. The processor 901 executes the computer program 903, to cause the communication device 90 to implement the method as described in the above method embodiments. In an embodiment, the memory 902 may have stored therein data. The communication device 90 and the memory 902 may be set separately or integrated together.

In an embodiment, the communication device 90 may further include a transceiver 904 and an antenna 905. The transceiver 904 may be called a transceiving element, a transceiving machine, a transceiving circuit or the like, for implementing a transceiving function. The transceiver 904 may include a receiver and a transmitter. The receiver may be called a receiving machine, a receiving circuit or the like, for implementing a receiving function. The transmitter may be called a sending machine, a sending circuit or the like for implementing a sending function.

In an embodiment, the communication device 90 may further include one or more interface circuits 906. The interface circuit 906 is configured to receive a code instruction and transmit the code instruction to the processor 901. The processor 901 runs the code instruction to enable the communication device 90 to execute the methods as described in the foregoing method embodiments.

The communication device 90 is a terminal device or a network side device.

In an implementation of the present disclosure, the processor 901 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The transceiver circuit, interface or interface circuit can be used for reading and writing codes/data, or the transceiver circuit, interface or interface circuit can be used for signal transmission or transfer.

In an implementation of the present disclosure, the processor 901 may be stored with a computer program 903, and the computer program 903 is performed by the processor 901, causing the communication device 90 to perform the method described in the above method embodiments. The computer program 903 may be solidified in the processor 901, in which case the processor 901 may be implemented by hardware.

In an implementation of the present disclosure, the communication device 90 may include a circuit, and the circuit may implement the functions of sending or receiving or communicating in the foregoing method embodiments. The processors and transceivers described in the present disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication device described in the above embodiments may be the network side device or the terminal device (e.g., the UE in the above method embodiments), but the scope of the communication device described in the present disclosure is not limited thereto, and the structure of the communication device may not be limited by FIG. 9. The communication device may be a stand-alone device or may be part of a larger device. For example, the communication device may be:
(1) a stand-alone integrated circuit IC, or chip, or chip system or subsystem;
(2) a set of one or more ICs. In embodiments of the present disclosure, the IC set may further include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network side device, a cloud device, an artificial intelligence device, and the like;
(6) others, etc.

For the case where the communication device may be a chip or a chip system, reference may be made to a schematic structural diagram of the chip shown in FIG. 10. The chip shown in FIG. 10 includes a processor 1001 and an interface 1002. In the chip, one or more processors 1001 may be provided, and more than one interface 1002 may be provided.

In an embodiment of the present disclosure, the chip further includes a memory 1003, and the memory 1003 is configured to store necessary computer programs and data.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure further provide a system for implementing an extended reality service policy. The system includes the communication device as the terminal device (such as the terminal device in the above method embodiments) and the communication device as the network side device in the above embodiments of FIG. 6, or the system includes the communication device as the terminal device (such as the terminal device in the above method embodiments) and the communication device as the network side device in the above embodiments of FIG. 9.

The present disclosure further provides a readable storage medium on which instructions are stored. When the instructions are performed by a computer, the functions of any of the above method embodiments are implemented.

The present disclosure further provides a computer program product, which, when been performed by a computer, implements the functions of any of the above method embodiments.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in the present disclosure are only distinctions made for convenience of description and are not used to limit the scope of the embodiments of the disclosure, nor to indicate the order.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

The correspondence shown in each table in the present disclosure may be configured or predefined. The values of information in each table are just examples, and may be configured as other values, which are not limited in the present disclosure. When configuring a correspondence between the information and various parameters, it is not necessary to configure all the correspondences shown in the tables. For example, the correspondences shown in some rows of the tables in the present disclosure may not be configured. For another example, appropriate deformations or adjustments (such as splitting, merging, and so on) can be made based on the above table. The names of parameters shown in the titles of the above tables may also adopt other names understandable by the communication device, and the values or representations of the parameters may also be other values or representations understandable by the communication device. When the above tables are implemented, other data structures may also be used, for example, arrays, queues, containers, stacks, linear tables, pointers, linked lists, trees, graphs, structural body, classes, heaps, or hash tables may be used.

The term “predefinition” in the present disclosure may be understood as definition, pre-definition, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, device and unit may refer to the corresponding process in the foregoing method embodiments, which will not be repeated here.

The above only describes some specific implementations of the present disclosure, but the protection scope of the present disclosure is not limited thereto. Any changes or substitutions that are conceivable to those skilled in the art within the technical scope of the present disclosure should fall within the protection scope of the present disclosure. Therefore, the protection scope of the present disclosure should be determined by the protection scope of the claims.

Embodiments of the present disclosure provide a method and apparatus for implementing an extended reality service policy, which can be applied to a communication system such as a long term evolution (LTE) system, a 5th generation (5G) mobile communication systems, a 5G New Radio (NR) system, or another future new mobile communication system, and can be beneficial to improving a transmission efficiency of a service data flow in a session and avoiding the waste of communication resource.

In a first aspect, embodiments of the present disclosure provide a method for implementing an extended reality service policy, which is applied to a Policy Control Function (PCF), and the method includes:
receiving an Application Function (AF) session creation request message, wherein first indication information in the AF session creation request message is configured to indicate a Packet Data Unit (PDU) session associated with an AF session requested by the AF session creation request message; and
‘associating the AF session with the PDU session according to the first indication information.

In some embodiments of the present disclosure, associating the AF session with the PDU session according to the first indication information includes:
updating policy information of the PDU session according to the first indication information to associate the AF session with the PDU session.

In some embodiments of the present disclosure, the method further includes:
sending a User Equipment Route Selection Policy (URSP) rule table to a User Equipment (UE), wherein the URSP rule table includes second indication information, and the second indication information is configured to indicate a corresponding XRM service.

In some embodiments of the present disclosure, the second indication information includes at least one of:
Extended Reality and Media (XRM) service indication information; or
application description information.

In some embodiments of the present disclosure, the method further includes:
sending the URSP rule table to the UE through a UE configuration update process.

In some embodiments of the present disclosure, the method further includes:
updating the URSP rule table according to capability information, subscription information or operator policy information of the UE, and sending the updated URSP rule table to the UE.

In some embodiments of the present disclosure, the first indication information includes at least one of:
Network Slice Selection Assistance Information (S-NSSAI) and a Data Network Name (DNN); or
an Application ID, wherein the Application ID corresponds to the S-NSSAI and the DNN.

In some embodiments of the present disclosure, the AF session creation request message includes at least one of:
an XRM service identifier;
an XRM group identifier;
a UE address or a UE identifier;
an AF identifier;
data flow description information; or
a Quality of Service (QoS) parameter.

In some embodiments of the present disclosure, the AF session creation request message is authorized by a Network Exposure Function (NEF).

In some embodiments of the present disclosure, the method further includes:
generating a policy decision feedback message according to the AF session creation request message authorized by the NEF and sending the policy decision feedback message to the NEF.

In some embodiments of the present disclosure, the policy information includes a Policy and Charging Control (PCC) rule and/or a QoS policy.

The AF session is determined by receiving the AF session creation request message for authorization, and the PDU session associated with the AF session requested by the AF session creation request message is obtained according to the second indication information, so that the PDU session is associated with the AF session by the PCF. Accordingly, for an XRM service of the same UE, data flows of the XRM service can use the same PDU session, which is beneficial to improve the transmission efficiency of the service data flow in the session and avoid waste of communication resources.

In a second aspect, embodiments of the present disclosure provide another method for implementing an extended reality service policy, which is applied to an Application Function (AF), and the method includes:
sending an AF session creation request message to a PCF through a NEF, wherein the AF session creation request message includes first indication information, and the first indication information is configured to indicate a PDU session associated with an AF session requested by the AF session creation request message.

In some embodiments of the present disclosure, the method further includes:
receiving, through the NEF, an AF session creation feedback message sent by the PCF.

In some embodiments of the present disclosure, the method further includes:
receiving an application request message which is sent by a UE through the PDU session, wherein the application request message includes information corresponding to the PDU session, and the information corresponding to the PDU session is the first indication information.

In some embodiments of the present disclosure, the AF session creation request message further includes at least one of:
an XRM service identifier; or
an XRM group identifier.

In some embodiments of the present disclosure, the first indication information includes at least one of:
S-NSSAI and a DNN; or
an Application ID, wherein the Application ID corresponds to the S-NSSAI and the DNN.

In some embodiments of the present disclosure, the AF session creation request message further includes at least one of:
a UE address or a UE identifier;
an AF identifier;
data flow description information; or
a QoS parameter.

The AF session creation request message is sent to the PCF through the NEF to create the AF session, and the PDU session associated with the AF session requested by the AF session creation request message is obtained according to the second indication information, so that the PDU session is associated with the AF session by the PCF. Accordingly, for an XRM service of the same UE, data flows of the XRM service can use the same PDU session, which is beneficial to improve the transmission efficiency of the service data flow in the session and avoid waste of communication resources.

In a third aspect, embodiments of the present disclosure provide another method for implementing an extended reality service policy, which is applied to a Network Exposure Function (NEF), and the method includes:
receiving an AF session creation request message sent by an AF, wherein the AF session creation request message includes first indication information, and the first indication information is configured to indicate a PDU session associated with an AF session requested by the AF session creation request message; and
authorizing the AF session creation request message, and sending the authorized AF session creation request message to the PCF to enable the PCF to associate the AF session with the PDU session.

In some embodiments of the present disclosure, the method further includes:
sending an AF session creation feedback message to the AF to notify the AF of an authorization result of the AF session creation request message.

In some embodiments of the present disclosure, the method further includes:
receiving a policy decision feedback message sent by the PCF, and feeding back the policy decision feedback message to the AF.

In some embodiments of the present disclosure, the first indication information includes at least one of:
S-NSSAI and a DNN; or
an Application ID, wherein the Application ID corresponds to the S-NSSAI and the DNN.

In some embodiments of the present disclosure, the AF session creation request message includes at least one of:
an XRM service identifier;
an XRM group identifier;
a UE address or a UE identifier;
an AF identifier;
data flow description information; or
a QoS parameter.

In some embodiments of the present disclosure, the method further includes:
creating a Time Sensitive Communication and Time Synchronization Function (TSCTSF) according to the AF identifier or the QoS parameter to communicate with the PCF.

The AF session is determined by authorizing the AF session creation request message, and the PDU session associated with the AF session requested by the AF session creation request message is obtained according to the second indication information, so that the PDU session is associated with the AF session by the PCF. Accordingly, for an XRM service of the same UE, data flows of the XRM service can use the same PDU session, which is beneficial to improve the transmission efficiency of the service data flow in the session and avoid waste of communication resources.

In a fourth aspect, embodiments of the present disclosure provide another method for implementing an extended reality service policy, which is applied to a User Equipment (UE), and the method includes:
obtaining a URSP rule table sent by a PCF, wherein the URSP rule table includes second indication information, and the second indication information is configured to indicate a corresponding XRM service;
obtaining an XRM service corresponding to a requested application; and
if the XRM service corresponding to the requested application is consistent with the XRM service corresponding to the second indication information, sending an application request message to an AF through a PDU session corresponding to the XRM service.

In some embodiments of the present disclosure, the second indication information includes at least one of:
XRM service indication information; or
application description information.

In some embodiments of the present disclosure, the application request message includes information corresponding to the PDU session to enable the PCF to associate an AF session created by the AF with the PDU session.

In some embodiments of the present disclosure, the information corresponding to the PDU session includes at least one of:
S-NSSAI and a DNN; or
an Application ID, wherein the Application ID corresponds to the S-NSSAI and the DNN.

In some embodiments of the present disclosure, the application request message includes an XRM service identifier or an XRM group identifier.

The PDU session corresponding to the transmission of the application request message is determined by the XRM service corresponding to the requested application and the second indication information in the URSP rule table, and the application request message is sent to the AF according to the existing PDU session, so that the AF creates an AF session associated with the PDU session. Accordingly, for an XRM service of the same UE, data flows of the XRM service can use the same PDU session, which is beneficial to improve the transmission efficiency of the XRM service and avoid waste of communication resources.

In a fifth aspect, embodiments of the present disclosure provide a communication device, which has part or all of functions for implementing the terminal device in the method according to the first aspect above. For example, the communication device may have functions as described in some or all the embodiments in the present disclosure, or may also have functions to separately implement any of embodiments in the present disclosure. The functions may be implemented by a hardware, or may be implemented by executing a corresponding software on the hardware. The hardware or the software includes one or more elements or modules corresponding to the above functions.

In an implementation, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

As an example, the processing module may be a processor, the transceiving module may be a transceiver or a communication interface, and the storage module may be a memory. In an implementation, the communication device includes:
a first transceiving module, configured to receive an Application Function (AF) session creation request message, wherein first indication information in the AF session creation request message is configured to indicate a Packet Data Unit (PDU) session associated with an AF session requested by the AF session creation request message; and
a session association module, configured to associate the AF session with the PDU session according to the first indication information.

In a sixth aspect, embodiments of the present disclosure provide a communication device, which has part or all of functions for implementing the terminal device in the method according to the first aspect above. For example, the communication device may have functions as described in some or all the embodiments in the present disclosure, or may also have functions to separately implement any of embodiments in the present disclosure. The functions may be implemented by a hardware, or may be implemented by executing a corresponding software on the hardware. The hardware or the software includes one or more elements or modules corresponding to the above functions.

In an implementation, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

As an example, the processing module may be a processor, the transceiving module may be a transceiver or a communication interface, and the storage module may be a memory. In an implementation, the communication device includes:
In a seventh aspect, embodiments of the present disclosure provide a communication device, which has part or all of functions for implementing the terminal device in the method according to the first aspect above. For example, the communication device may have functions as described in some or all the embodiments in the present disclosure, or may also have functions to separately implement any of embodiments in the present disclosure. The functions may be implemented by a hardware, or may be implemented by executing a corresponding software on the hardware. The hardware or the software includes one or more elements or modules corresponding to the above functions.

In an implementation, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

As an example, the processing module may be a processor, the transceiving module may be a transceiver or a communication interface, and the storage module may be a memory. In an implementation, the communication device includes:
a second transceiving module, configured to send an Application Function (AF) session creation request message to a Policy Control Function (PCF) through a Network Exposure Function (NEF), wherein the AF session creation request message includes first indication information, and the first indication information is configured to indicate a Packet Data Unit (PDU) session associated with an AF session requested by the AF session creation request message;
a third transceiving module, configured to receive an Application Function (AF) session creation request message sent by an AF, wherein the AF session creation request message includes first indication information, and the first indication information is configured to indicate a Packet Data Unit (PDU) session associated with an AF session requested by the AF session creation request message; and
an authorization module, configured to authorize the AF session creation request message, and sending the authorized AF session creation request message to a Policy Control Function (PCF) to enable the PCF to associate the AF session with the PDU session.

In an eighth aspect, embodiments of the present disclosure provide a communication device, which has part or all of functions for implementing the terminal device in the method according to the first aspect above. For example, the communication device may have functions as described in some or all the embodiments in the present disclosure, or may also have functions to separately implement any of embodiments in the present disclosure. The functions may be implemented by a hardware, or may be implemented by executing a corresponding software on the hardware. The hardware or the software includes one or more elements or modules corresponding to the above functions.

In an implementation, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

As an example, the processing module may be a processor, the transceiving module may be a transceiver or a communication interface, and the storage module may be a memory. In an implementation, the communication device includes:
a rule updating module, configured to obtain a User Equipment Route Selection Policy (URSP) rule table sent by a Policy Control Function (PCF), wherein the URSP rule table includes second indication information, and the second indication information is configured to indicate a corresponding Extended Reality and Media (XRM) service;
a service obtaining module, configured to obtain an XRM service corresponding to a requested application; and
a fourth transceiving module, configured to, if the XRM service corresponding to the requested application is consistent with the XRM service corresponding to the second indication information, send an application request message to an Application Function (AF) through a Packet Data Unit (PDU) session corresponding to the XRM service.

In a ninth aspect, embodiments of the present disclosure provide a communication device, which includes a processor which, when invokes a computer program in a memory, executes the method according to the first aspect above.

In a tenth aspect, embodiments of the present disclosure provide a communication device, which includes a processor which, when invokes a computer program in a memory, executes the method according to the second aspect above.

In an eleventh aspect, embodiments of the present disclosure provide a communication device, which includes a processor which, when invokes a computer program in a memory, executes the method according to the third aspect above.

In a twelfth aspect, embodiments of the present disclosure provide a communication device, which includes a processor which, when invokes a computer program in a memory, executes the method according to the fourth aspect above.

In a thirteenth aspect, embodiments of the present disclosure provide a communication device, including a processor and a memory having a computer program stored thereon. The processor executes the computer program stored in the memory, to cause the communication device to implement the method according to the first aspect above.

In a fourteenth aspect, embodiments of the present disclosure provide a communication device, including a processor and a memory having a computer program stored thereon. The processor executes the computer program stored in the memory, to cause the communication device to implement the method according to the second aspect above.

In a fifteenth aspect, embodiments of the present disclosure provide a communication device, including a processor and a memory having a computer program stored thereon. The processor executes the computer program stored in the memory, to cause the communication device to implement the method according to the third aspect above.

In a sixteenth aspect, embodiments of the present disclosure provide a communication device, including a processor and a memory having a computer program stored thereon. The processor executes the computer program stored in the memory, to cause the communication device to implement the method according to the fourth aspect above.

In a seventeenth aspect, embodiments of the present disclosure provide a communication device, including a processor and an interface circuit. The interface circuit is configured to receive a code instruction and transmit the code instruction to the processor, and the processor is configured to run the code instruction to cause the device implement the method according to the first aspect above.

In an eighteenth aspect, embodiments of the present disclosure provide a communication device, including a processor and an interface circuit. The interface circuit is configured to receive a code instruction and transmit the code instruction to the processor, and the processor is configured to run the code instruction to cause the device implement the method according to the second aspect above.

In a nineteenth aspect, embodiments of the present disclosure provide a communication device, including a processor and an interface circuit. The interface circuit is configured to receive a code instruction and transmit the code instruction to the processor, and the processor is configured to run the code instruction to cause the device implement the method according to the third aspect above.

In a twentieth aspect, embodiments of the present disclosure provide a communication device, including a processor and an interface circuit. The interface circuit is configured to receive a code instruction and transmit the code instruction to the processor, and the processor is configured to run the code instruction to cause the device implement the method according to the fourth aspect above.

In a twenty-first aspect, embodiments of the present disclosure provide a system for implementing an extended reality service policy, which includes the communication device described in the fifth aspect, the sixth aspect, the seventh aspect or the eighth aspect, or includes the communication device described in the ninth aspect, the tenth aspect, the eleventh aspect or the twelfth aspect, or includes the communication device described in the thirteenth aspect, the fourteenth aspect, the fifteenth aspect or the sixteenth aspect, or includes the communication device described in the seventeenth aspect, the eighteenth aspect, the nineteenth aspect or the twentieth aspect.

In a twenty-second aspect, embodiments of the present disclosure provide a computer-readable storage medium for storing instructions used by the above-mentioned terminal device. The instructions, when executed, cause the terminal device to implement the method according to the first aspect above.

In a twenty-third aspect, embodiments of the present disclosure provide a readable storage medium for storing instructions used by the above-mentioned network side device. The instructions, when executed, cause the network side device to implement the method according to the second aspect above.

In a twenty-fourth aspect, embodiments of the present disclosure provide a computer-readable storage medium for storing instructions used by the above-mentioned terminal device. The instructions, when executed, cause the terminal device to implement the method according to the third aspect above.

In a twenty-fifth aspect, embodiments of the present disclosure provide a readable storage medium for storing instructions used by the above-mentioned network side device. The instructions, when executed, cause the network side device to implement the method according to the fourth aspect above.

In a twenty-sixth aspect, the present disclosure further provides a computer program product including a computer program which, when run on a computer, causes the computer to implement the method according to the first aspect above.

In a twenty-seventh aspect, the present disclosure further provides a computer program product including a computer program which, when run on a computer, causes the computer to implement the method according to the second aspect above.

In a twenty-eighth aspect, the present disclosure further provides a computer program product including a computer program which, when run on a computer, causes the computer to implement the method according to the third aspect above.

In a twenty-ninth aspect, the present disclosure further provides a computer program product including a computer program which, when run on a computer, causes the computer to implement the method according to the fourth aspect above.

In a thirtieth aspect, the present disclosure provides a chip system, which includes at least one processor and an interface, configured to support a terminal device to implement functions involved in the first aspect, for example, determining or processing at least one of data and information involved in the above method. In a possible design, the chip system further includes a memory for storing necessary computer programs and data of the terminal device. The chip system may consist of chips, or may include chips and other discrete devices.

In a thirty-first aspect, the present disclosure provides a chip system, which includes at least one processor and an interface, configured to support a network side device to implement functions involved in the second aspect, for example, determining or processing at least one of data and information involved in the above method. In a possible design, the chip system further includes a memory for storing necessary computer programs and data of the network side device. The chip system may consist of chips, or may include chips and other discrete devices.

In a thirty-second aspect, the present disclosure provides a chip system, which includes at least one processor and an interface, configured to support a terminal device to implement functions involved in the third aspect, for example, determining or processing at least one of data and information involved in the above method. In a possible design, the chip system further includes a memory for storing necessary computer programs and data of the terminal device. The chip system may consist of chips, or may include chips and other discrete devices.

In a thirty-third aspect, the present disclosure provides a chip system, which includes at least one processor and an interface, configured to support a network side device to implement functions involved in the fourth aspect, for example, determining or processing at least one of data and information involved in the above method. In a possible design, the chip system further includes a memory for storing necessary computer programs and data of the network side device. The chip system may consist of chips, or may include chips and other discrete devices.

In a thirty-fourth aspect, the present disclosure provides a computer program which, when run on a computer, causes the computer to implement the method according to the first aspect above.

In a thirty-fifth aspect, the present disclosure provides a computer program which, when run on a computer, causes the computer to implement the method according to the second aspect above.

In a thirty-sixth aspect, the present disclosure provides a computer program which, when run on a computer, causes the computer to implement the method according to the third aspect above.

In a thirty-seventh aspect, the present disclosure provides a computer program which, when run on a computer, causes the computer to implement the method according to the fourth aspect above.

1. A method for implementing an extended reality service policy, applied to a Policy Control Function (PCF), and comprising:
receiving an Application Function (AF) session creation request message, wherein first indication information in the AF session creation request message is configured to indicate a Packet Data Unit (PDU) session associated with an AF session requested by the AF session creation request message; and
associating the AF session with the PDU session according to the first indication information.

2. The method according to claim 1, wherein associating the AF session with the PDU session according to the first indication information comprises:
updating policy information of the PDU session according to the first indication information to associate the AF session with the PDU session.

3. The method according to claim 1, wherein the method further comprises:
sending a User Equipment Route Selection Policy (URSP) rule table to a User Equipment (UE), wherein the URSP rule table comprises second indication information, and the second indication information is configured to indicate a corresponding Extended Reality and Media (XRM) service; and
wherein the second indication information comprises at least one of:
XRM service indication information; or
application description information.

4. (canceled)

5. The method according to claim 3, wherein the method further comprises:
sending the URSP rule table to the UE through a UE configuration update process.

6. The method according to claim 5, wherein the method further comprises:
updating the URSP rule table according to operator policy information, subscription information or capability information of the UE, and sending the updated URSP rule table to the UE.

7. The method according to claim 1, wherein the first indication information comprises at least one of:
Network Slice Selection Assistance Information (S-NSSAI) and a Data Network Name (DNN); or
an Application ID, wherein the Application ID corresponds to the S-NSSAI and the DNN; and
wherein the AF session creation request message comprises at least one of:
an XRM service identifier:
an XRM group identifier;
a UE address or a UE identifier;
an AF identifier;
data flow description information; or
a Quality of Service (QoS) parameter.

8. (canceled)

9. The method according to claim 1, wherein the AF session creation request message is authorized by a Network Exposure Function (NEF); and
wherein the method further comprises:
generating a policy decision feedback message according to the AF session creation request message authorized by the NEF and sending the policy decision feedback message to the NEF.

10. (canceled)

11. The method according to claim 2, wherein the policy information comprises a Policy and Charging Control (PCC) rule and/or a QoS policy.

12. A method for implementing an extended reality service policy, applied to an Application Function (AF), and comprising:
sending an Application Function (AF) session creation request message to a Policy Control Function (PCF) through a Network Exposure Function (NEF), wherein the AF session creation request message comprises first indication information, and the first indication information is configured to indicate a Packet Data Unit (PDU) session associated with an AF session requested by the AF session creation request message.

13. The method according to claim 12, wherein the method further comprises:
receiving, through the NEF, an AF session creation feedback message sent by the PCF.

14. The method according to claim 12, wherein the method further comprises:
receiving an application request message which is sent by a User Equipment (UE) through the PDU session, wherein the application request message comprises information corresponding to the PDU session, and the information corresponding to the PDU session is the first indication information.

15. The method according to claim 12, wherein the AF session creation request message further comprises at least one of:
an Extended Reality and Media (XRM) service identifier; or
an XRM group identifier;
wherein the first indication information comprises at least one of:
Network Slice Selection Assistance Information (S-NSSAI) and a Data Network Name (DNN); or
an Application ID, wherein the Application ID corresponds to the S-NSSAI and the DNN; and
wherein the AF session creation request message further comprises at least one of:
a UE address or a UE identifier;
an AF identifier;
data flow description information; or
a Quality of Service (QoS) parameter.

16-17. (canceled)

18. A method for implementing an extended reality service policy, applied to a Network Exposure Function (NEF), and comprising:
receiving an Application Function (AF) session creation request message sent by an AF, wherein the AF session creation request message comprises first indication information, and the first indication information is configured to indicate a Packet Data Unit (PDU) session associated with an AF session requested by the AF session creation request message; and
authorizing the AF session creation request message, and sending the authorized AF session creation request message to a Policy Control Function (PCF) to enable the PCF to associate the AF session with the PDU session.

19. The method according to claim 18, wherein the method further comprises:
sending an AF session creation feedback message to the AF to notify the AF of an authorization result of the AF session creation request message.

20. The method according to claim 18, wherein the method further comprises:
receiving a policy decision feedback message sent by the PCF, and feeding back the policy decision feedback message to the AF.

21. The method according to claim 18, wherein the first indication information comprises at least one of:
Network Slice Selection Assistance Information (S-NSSAI) and a Data Network Name (DNN); or
an Application ID, wherein the Application ID corresponds to the S-NSSAI and the DNN.

22. The method according to claim 18, wherein the AF session creation request message comprises at least one of:
an Extended Reality and Media (XRM) service identifier;
an XRM group identifier;
a User Equipment (UE) address or a UE identifier;
an AF identifier;
data flow description information; or
a Quality of Service (QoS) parameter; and
wherein the method further comprises:
creating a Time Sensitive Communication and Time Synchronization Function (TSCTSF) according to the AF identifier or the QoS parameter to communicate with the PCF.

23-35. (canceled)

36. A communication device, comprising a processor and a memory, wherein a computer program is stored in the memory, and the processor executes the computer program stored in the memory to cause the communication device to execute the method according to claim 1.

37. A communication device, comprising a processor and a memory, wherein a computer program is stored in the memory, and the processor executes the computer program stored in the memory to cause the communication device to execute the method according to claim 12.

38. A communication device, comprising a processor and a memory, wherein a computer program is stored in the memory, and the processor executes the computer program stored in the memory to cause the communication device to execute the method according to claim 18.
